(19) United States
(12) Patent Application Publication
(10) Pub. No.: US 2009/0273586 A1
(43) Pub. Date: Nov. 5, 2009

(54) DEVICE AND METHOD FOR COMPOSING AND HANDLING MESSAGES

(75) Inventor: Ido Gert DE HAAN, Assen (NL)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: Sony Ericsson Mobile Communications AB, Lund (SE)

(21) Appl. No.: 12/192,508

(22) Filed: Aug. 15, 2008

Related U.S. Application Data
(63) Continuation-in-part of application No. 12/112,050, filed on Apr. 30, 2008.

(51) Int. Cl. G06F 3/033

(52) U.S. Cl. 345/179

(57) ABSTRACT

A message composing device adapted for being used with for example handheld, portable communication devices such as a mobile phone, is provided together with a method for composing sending and receiving information between other communication devices.

### CROSS-REFERENCE TO RELATED APPLICATION

This application is a continuation-in-part of U.S. Non-provisional patent application Ser. No. 12/112,050 filed Apr. 30, 2008, the entire disclosure of which is hereby incorporated by reference.

### TECHNICAL FIELD

The present invention relates to a device and method for composing and handling text messages and being arranged for communication with a further device.

### BACKGROUND ART

Today, there exist many types of electronic devices such as mobile devices, media players, palmtop computers etc. Mobile devices such as mobile phones, for example, are normally equipped with a communications protocol forming part of the GSM system and allowing transmission of text messages between such mobile phones.

According to known technology, text messages, such as SMS, email, Instant messaging can be composed and entered by the user into the mobile phone by using the keypad of the phone. More precisely, characters such as letters, digits and other symbols are entered into the phone manually by pressing the corresponding keys on the keypad.

An alternative way of entering characters forming a text message is by using a so-called stylus, i.e. a pointed, pencil-like writing tool which is used in many of today's mobile phones for entering characters by “writing” on a touch sensitive screen forming part of the phone. Today, such a combination of a stylus and a “writing pad” in the form of a touch sensitive screen is relatively common and can often be regarded as more user-friendly than entering characters manually via a keypad.

Existing methods, for example entering information via a keypad or by means of a stylus cooperating with a touch screen, are not always sufficiently easy and quick to use.

Even though the above-mentioned known methods of entering information are relatively straight-forward for a user of a mobile device such as a mobile phone, there is an increasing demand in the mobile phone market for even more easy, quick and user-friendly ways of operating a mobile phone.

In particular, with regard to Instant messaging and email there is a need to simplify the user interaction with the mobile phone and there is a need for faster, easier and more intuitive ways of composing and sending text messages by means of easy and convenient input methods.

### SUMMARY OF THE INVENTION

With the above and following description in mind, an aspect of the present invention is to provide a message composing device adapted for being used with for example handheld, portable devices such as a mobile phone, in which the above-mentioned drawbacks can be overcome, and which can be used for providing a more user-friendly and effective way of composing and sending/receiving information between other communication devices.

An aspect of the present invention relates to a method for sending messages by using a message composing device adapted for cooperation with a communication device. The method comprises the steps of setting the message composing device in a writing operating mode, recognizing characters, symbols or similar information using detection of movements of the message composing device, communicating the characters, symbols or similar information to the communication device, setting the communication device in a sending operating mode and sending the characters, symbols or similar information dependent on the sending operating mode by using the communication device.

In one embodiment the sending operating mode may be set to sending the characters, symbols or similar information as an Instant message.

In one embodiment the method for sending messages may further comprise the step of composing a message comprising the characters, symbols or similar information and wherein the sending operating mode may be set to sending the message as an email, sms or the like.

In one embodiment the detection step may be carried out by means of at least one accelerometer being arranged in the message composing device.

In one embodiment the detection step may be carried out by means of at least one optical detector means being arranged in the message composing device.

In one embodiment the method for sending messages may further comprise the step of presenting the characters, symbols or similar information on a display. Further on the characters, symbols or similar information may be presented in real time. The display may be arranged on the message composing device and/or on the communication device.

In one embodiment the steps of setting an operating mode may be performed by using a selecting unit arranged on the message composing device.

In one embodiment the steps of setting an operating mode may be performed on the communication device.

In one embodiment the method for sending may further comprise steps of detecting a change of position of the message composing device. The detected change of position may correspond to a change of the operating mode.

In one embodiment the communicating step may be provided via a wireless connection. The wireless connection may be arranged in accordance with the Bluetooth wireless protocol.

In one embodiment the communicating step may be provided via a wired connection.

In one embodiment the communication device may be a mobile phone, portable computer or similar communication device.

An aspect of the present invention relates to a method for receiving and replying to messages by using a message composing device adapted for cooperation with a first communication device. The method comprises the steps of receiving a message on the first communication device from a second communication device, presenting the received message on a first display, replying to the received message. The step of replying further comprises the steps of setting the message composing device in a writing operating mode, recognizing characters, symbols or similar information using detection of movements of the message composing device, communicating the characters, symbols or similar information to the first communication device, setting the first communication device in a sending operating mode and sending the characters, symbols or similar information dependent on the sending operating mode.

In one embodiment the sending operating mode may be set to sending the message as an Instant message.

In one embodiment the sending operating mode may be set to sending the message as an email, sms or the like.

In one embodiment the method for receiving and replying to messages may further comprise the step of presenting the recognized characters, symbols or similar information on the first display.

In one embodiment the method for receiving and replying to messages may further comprise the step of presenting the received message on a second display and presenting the recognized characters, symbols or similar information on the second display. The recognized characters, symbols or similar information may be presented in real time on the second display.

In one embodiment the first display may be arranged on the communication device and the second display may be arranged on the message composing device.

In one embodiment the communicating step may be provided via a wireless connection. The wireless connection may be arranged in accordance with the Bluetooth wireless protocol.

In one embodiment the communicating step may be provided via a wired connection.

In one embodiment the first and second communication devices may be a mobile phone, portable computer or similar communication device.

An aspect of the present invention relates to a message composing device adapted for cooperation with a communication device. The device comprises means for setting the message composing device in writing operating mode, means for recognizing characters, symbols or similar information using means for detecting movements of the message composing device, means for communicating said characters, symbols or similar information to said communication device and means for setting said communication device in a sending operating mode.

In one embodiment the sending operating mode may be set to sending the characters, symbols or similar information as an Instant message.

In one embodiment the sending operating mode may be set to sending the characters, symbols or similar information as an email, sms or the like.

In one embodiment the means for detecting movements comprises at least one accelerometer.

In one embodiment the means for detecting movements comprises at least one optical detector means.

In one embodiment the device may further comprise a display for presenting the characters, symbols or similar information. The characters, symbols or similar information may be presented in real time on the display.

In one embodiment the means for setting sending operating mode may be a selecting unit provided on the device.

In one embodiment the means for detecting movements may further be adapted for detecting a change of position of the device. The detected change of position may correspond to a change of operating mode.

In one embodiment the device may be arranged for communicating with the communication device via a wireless connection. The wireless connection may be arranged in accordance with the Bluetooth wireless protocol.

In one embodiment the device may be arranged for communicating with the communication device via a wired connection.

In one embodiment the device may comprise a housing which may be stylus shaped.

In one embodiment the communication device may be a mobile phone, portable computer or similar communication device.

It is an advantage with some embodiments of the invention that it provides for an easy and intuitive way of using a handwriting device for composing and sending/receiving messages.

### BRIEF DESCRIPTION OF THE DRAWINGS

Further objects, features and advantages of the present invention will appear from the following detailed description of some embodiments of the invention, wherein some embodiments of the invention will be described in more detail with reference to the accompanying drawings, in which:

FIG. 1 shows a schematic view of a mobile phone communicating with a message composing device according to the present invention;

FIG. 2 is a schematic block diagram of a message composing device and a mobile phone of the above-mentioned type;

FIG. 3 shows a schematic view of a user using the message composing device in FIG. 1;

FIG. 4 is a schematic view of a message composing pen with a display according to one embodiment of the present invention.

### DETAILED DESCRIPTION

Embodiments of the present invention relate, in general, to the field of mobile terminals including a message composing device. One embodiment relates to a mobile terminal, such as a mobile phone, including a digital device with message composing functions. However, although the invention is particularly suitable for mobile phones, it is as such equally applicable to other electronic devices which include radio communication capabilities and the shape of the message composing device may be of any shape. However, for the sake of clarity and simplicity, the embodiments outlined herein are related to mobile phones with a pen device.

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to persons skilled in the art. Like reference signs refer to like elements throughout.

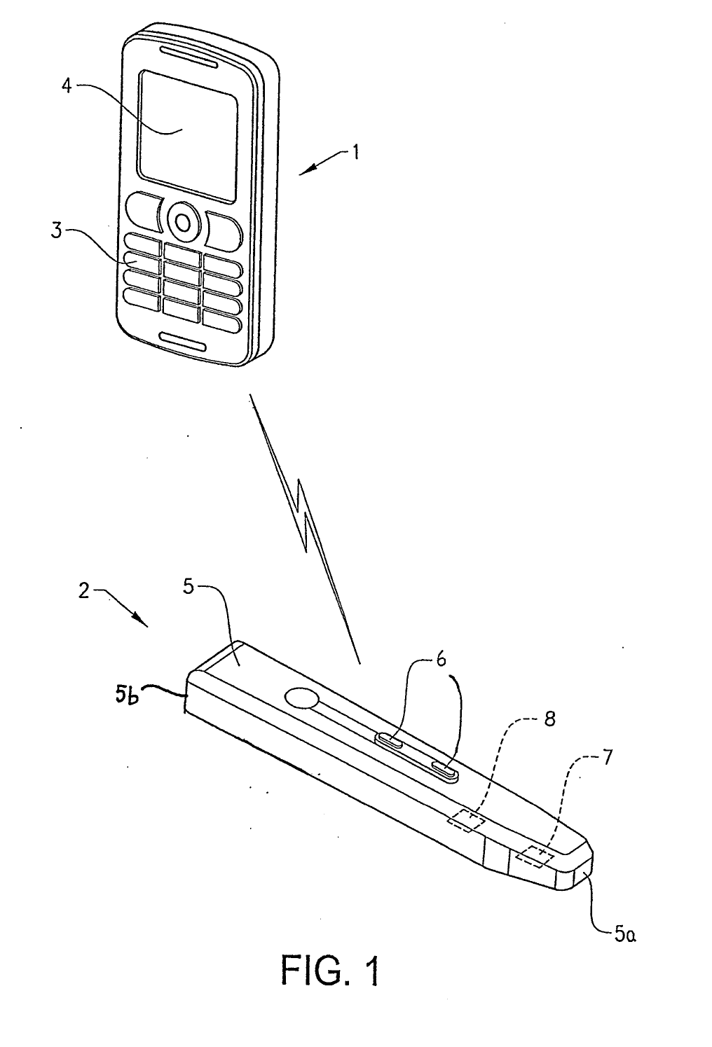

With reference to FIG. 1, there is shown a schematic view of a handheld, mobile phone 1 being associated with and communicating with a handheld message composing device 2, a pen device. The pen device 2 according to the invention may equally well be used, for example, together with another device in the form of a palmtop computer, an electronic game unit, a media player (for example a so-called mp3 player), a smartphone, a handheld DVD player, a pager and similar devices.

In a conventional manner, the mobile phone 1 is provided with a keypad 3 and a display 4. As indicated schematically in FIG. 1, the communication between the mobile phone 1 and the pen device 2 may be wireless, by means of a wireless communications protocol such as for example the Bluetooth wireless protocol. The manner in which different units communicate via the Bluetooth protocol is previously known as such, and for this reason it will not be described in detail here. The communication may also be wired by means of a wired communication line between the mobile phone 1 and the pen device 2 i.e. the invention is not limited to wireless communication between a mobile phone and the pen device.

It can furthermore be noted that the principles of the present invention can also be implemented in a headset or mouse device being connected to a mobile communication device.

In one embodiment, as shown in FIG. 1, the pen device 2 comprises a housing 5. The housing 5 may be shaped generally as a pen, i.e. having an elongated design with one pointed front portion 5a similar to the tip of a pencil and one blunted rear portion 5b. However, the invention is not limited to any particular type of shape or design of the housing 5.

The pen device 2 may be used as a writing tool for inputting information to be sent to other communication devices by using the mobile phone 1. For example, such information may be sent as an Instant Messaging message (hereinafter referred to as “IM”), an electronic mail message (hereinafter referred to as “email”), SMS, MMS or the like.

The pen device 2 according to the embodiment shown in FIG. 1 is provided with a motion detector 7 for identifying movements of the pen device 2 corresponding to writing-like movements. Further on the motion detector may also be used for identifying the position of the pen device, such as if it is turned upside down or shaken. The pen device 2 may also be provided with a switching device 8 for switching between different operations modes, such as writing/composing message, sending or receiving messages.

When the pen device 2 is in writing mode, as described above, writing-like movements of the pen device are performed by the user of the pen device 2. The movements are detected by the motion detector 7 and transformed into characters, symbols or other information to be fed into the mobile phone 1 where they may be stored or sent instantly as IM or email.

While writing whole or parts of messages as described above, the characters are suitably presented in real-time on the display 4 of the mobile phone 1 and/or on a display 9 provided on the pen device 2.

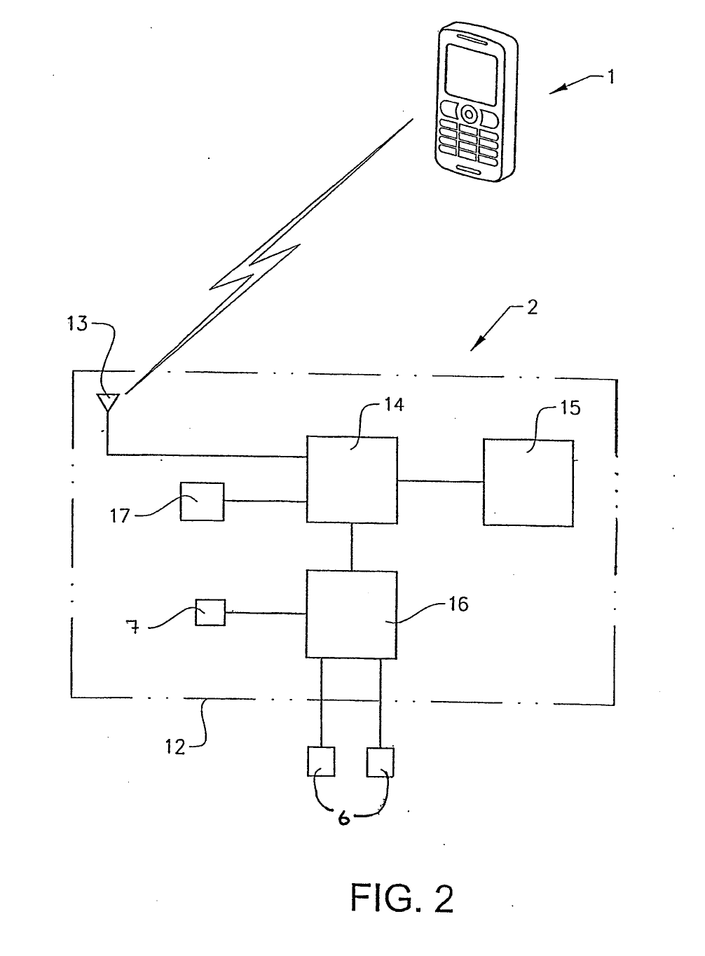

The manner in which the motion detector 7 is arranged in order to use the pen device 2 as a writing/sending/receiving tool will now be described with further reference to FIG. 2, which is a block diagram of a number of components forming part of the pen device 2 and the mobile phone 1 of the above-mentioned type.

FIG. 2 shows a block diagram of a control unit 12 which is preferably mounted as an integrated unit inside the housing 5 of the pen device 2. The control unit 12 comprises an antenna 13 which is arranged for communicating with the mobile phone 1, suitably via the Bluetooth wireless protocol as mentioned above. The antenna 13 is connected to a microprocessor 14 arranged for controlling the transmission of signals between the pen device 2 and the mobile phone 1.

Furthermore, the above-mentioned motion detector 7 is connected to an I/O (input/output) unit 16. The motion detector 7 is used for providing input signals indicating movements of the pen device 2 along a generally horizontal plane (x and y directions) or alternatively movements both along a horizontal plane and also along a vertical direction (z direction), i.e. transversal to both the x and y directions. Such signals can be used in order to detect a pattern of movement of the pen device 2. More precisely, when a user moves the pen device 2 in a fashion similar to writing with a pencil, the motion detector 7 will output a signal corresponding to the direction of movement and the acceleration of the movement. This signal is fed to a character recognition unit 17 for translating the signals from the motion detector 7 into corresponding characters, symbols and/or other pieces of information.

A microcontroller 14 of the pen device 2 is arranged for outputting and transmitting the translated signals to the mobile phone 1. Further on the mobile phone 1 is arranged for receiving the signals from microprocessor 14, via a wireless connection, i.e. the Bluetooth protocol as described above or a wired connection.

The motion detector 7 to be used within the frame of this invention is generally arranged to sense and convert an external acceleration force acting on the pen device 2 and being detected as motion. Such motion would result from movement of the pen device 2 in a manner similar to writing with a pencil. Due to the shape of the housing (cf. FIG. 1), it can be held with a grip just like a pencil such that the pointed end part 5a of the housing 5 would simulate the tip of the pencil. When writing the message (such as when composing a message), the user will hold the pen device in one hand and have it positioned in a hand similar to a ballpoint pen.

In one embodiment the motion detector 7 may be provided with optical units used for motion detection, similar to the units used in an optical computer mouse.

In one embodiment the motion detector 7 may be provided with at least one accelerometer. The accelerometer can be of any conventional type such as of capacitive, piezoelectric or piezoresistive type. The accelerometer may be of the 2D type, i.e. indicating movements only in x-y direction. In such a case, the writing movements of the pen device 2 along a generally horizontal plane can be detected. Such a situation would correspond to a user “writing” with the pen device 2 on a surface such as a table or a paper. As an alternatively, the mobile phone 1 can be equipped with a screen having dimensions and design allowing it to be used as a writing pad. This means that the user would use the pen device 2 for writing movement directly on such a screen. Alternatively, the accelerometer can be of the 3D type, which means that also movement in a z direction, i.e. “up and down”, can be detected.

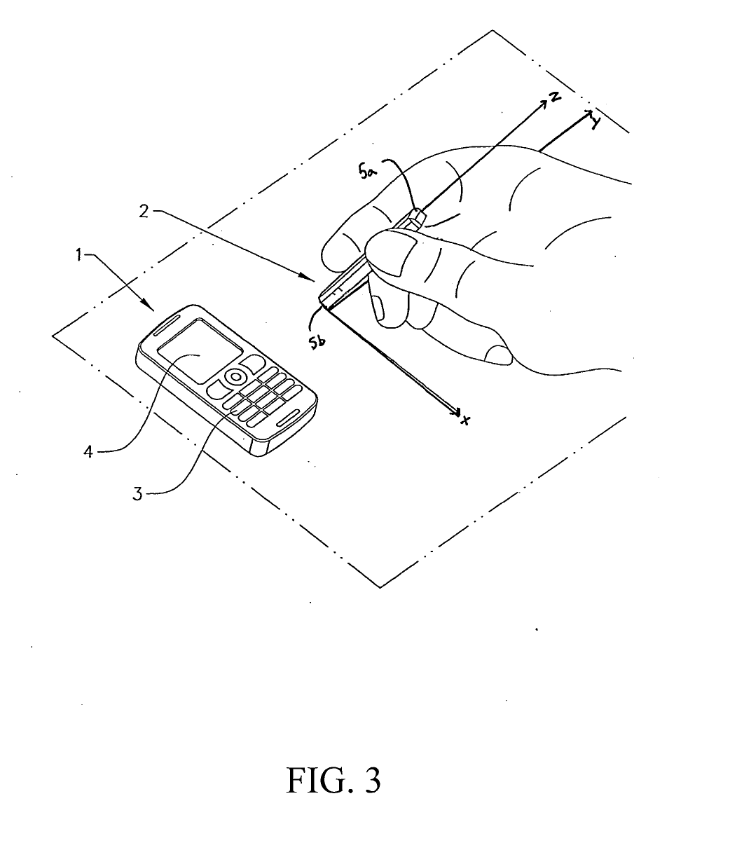

In one embodiment, as shown in FIG. 3, an accelerometer of the 3D type is used, i.e. indicating movements in x-y-z direction. This means that also movements of the pen device 2 along a generally horizontal plane, “up and down” or “upside down” may be detected. By means of detecting acceleration in each of the three axes the pen device 2 will be able to identify when the position of the pen device 2 is changed.

FIG. 3 is a perspective view of a pen device 2 according to an embodiment of the invention, being in use. Accordingly, FIG. 3 shows the pen device 2 being held in the hand of a user and being gripped generally in the same manner as a pencil. The pen device 2 is suitable held so that it is pointed towards a surface on which the mobile phone 1 is placed.

As is described above, the pen device 2 is arranged for detecting and converting writing-like movements into characters and symbols. When the motion detector 7 detects the writing position of the pen device 2 the pen device 2 is set in a writing operation mode. When the motion detector detects a movement in the x-y plane, writings or drawings is detected, translated and transmitted to the mobile phone 1. If the pen device 2 is being turned upside down, shaken, tapped etc, the motion detector 7 detects a change of position of the pen device 2 in i.e. z-direction and operation mode of the pen device 2 may be changed.

As an example, the user holds the pen device 2 in writing position, the operation mode is set to writing operation mode, the user writes a message with the pen device 2, when the user wish to send the message the user turns the pen device 2 upside down, the motion detector 7 detects a change of position and the operation mode is changed into sending operation mode.

In one embodiment according to the invention, a movement or change of position may be made around or along any of the three axes, x, y or z, which may trigger alteration of an operation mode of the pen device 2. There may be at least two different operation modes of the pen device 2 according to the invention. Examples of operation modes may be writing or communicating, such as sending or receiving a message etc.

The characters may be shown in real-time on a display while composing the messages, as described above.

In one embodiment, the display of the mobile phone 1 is used for presenting the written characters.

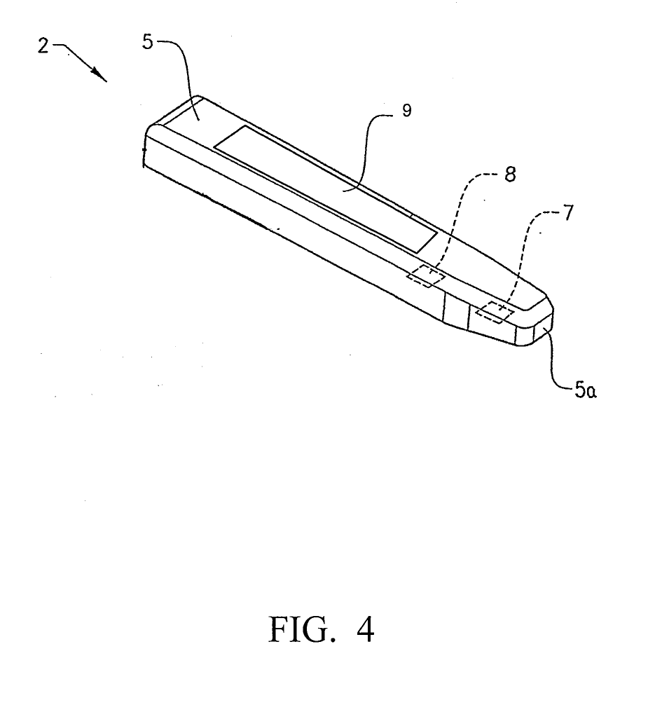

In one embodiment according to the invention, as shown in FIG. 4, a display 9 is arranged on the outside of the housing 5 of the pen device 2. The display 9 may be used for presenting the characters in real-time or for presenting a received message. Also the status, such as offline or online, may be shown on the display 9. Alternatively, the written characters may be shown in real-time on the display 9 of the pen device 2 and the received messages may be shown on the display 4 of the mobile phone 1.

The pen device 2 shown in FIG. 1 is in a slightly simplified manner. It is apparent that a pen device 2 such as the one shown in FIG. 1 may comprise user interface controls such as buttons, switches and similar components. As an example of such a user interface control, a switch button 6 is shown. According to the embodiment shown, the switch button 6 may be used for selecting operation mode by a user, such as switching between writing/composing message mode and sending/receiving mode. Other examples may be switching to sending IM mode, sending email mode, drawing mode, online or offline mode etc.

In one embodiment, the selecting/changing operation mode may be provided for on the mobile phone 1.

In one embodiment, the user decides to send a message. The user sets the pen device 2 in a writing operating mode, either by switching a button 6 on the pen device 2, selecting writing mode on the mobile phone 1 or to grip the pen device 2 in the writing position. Then the user starts “writing the message” with the pen device 2. The movement detector 7 detects writing like movements, transmits the signals corresponding to the movement to a recognition unit 17, which translates the movement signals into characters, the character signals communicates to the mobile phone 1. The detected characters may be presented on the display 9 of the pen device 2, on the display 4 of the mobile phone 1 or on both. If the user want to use IM the user selects IM operating mode on the pen device 2 or on the mobile phone and the characters will be sent as an IM message in a way that is commonly known and will not be explained any further. If the user wants to send the message, as email, SMS or others, the characters will be composed into a message which will be sent when the user selects send mode. The selection may be performed on the pen device 2 or on the mobile phone 1. When the send mode is selected the message is sent by triggering the sending operation. This may be done by changing the position of the pen device 2, switching a button on the pen device 2 or selecting SEND on the mobile phone 1.

In one embodiment, the user receives a message, which may be presented on the pen device 2, on the mobile phone 1 or on both, and decide to reply to the received message. The reply procedure may be the same as described above regarding the sending process.

The invention is not limited to the embodiment described above, but may be modified without departing from the scope of the claims below. For example, the invention can be used in portable, handheld terminals such as mobile phones, but is not limited to this type of use only but can be used in media players, computers, smart phones, game units, DVD players, pagers and similar devices.

Furthermore, it should be mentioned that the interpretation of the movement data, as detected by the motion detector 7, can be done by algorithms inside the control unit 12, i.e. in the recognition unit 17 or by algorithms in the mobile phone 1.

The invention may be implemented by suitable combinations of software and hardware as is known in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The foregoing has described the principles, embodiments and modes of operation of the present invention. However, the invention should be regarded as illustrative rather than restrictive, and not as being limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the following claims.

1. A method for sending a message by using a message composing device adapted for cooperation with a communication device, wherein said method comprises the steps of:
setting said message composing device in a writing operating mode;
recognizing characters, symbols or similar information using detection of movements of said message composing device;
communicating said characters, symbols or similar information to said communication device;
setting said communication device in a sending operating mode; and
sending said characters, symbols or similar information dependent on said sending operating mode by using said communication device.

2. The method for sending messages according to claim 1, wherein said sending operating mode is set to sending said characters, symbols or similar information as an Instant message.

3. The method for sending messages according to claim 1, further comprising the step of composing a message comprising said characters, symbols or similar information and wherein said sending operating mode is set to sending said message as an email.

4. The method for sending messages according to claim 1, wherein said detection step is carried out by means of at least one accelerometer being arranged in said message composing device.

5. The method for sending messages according to claim 1, wherein said detection step is carried out by means of at least one optical detector means being arranged in said message composing device.

6. The method for sending messages according to claim 1, further comprising the step of presenting said characters, symbols or similar information on a display.

7. The method for sending messages according to claim 4, wherein said presenting step further comprises presenting said characters, symbols or similar information in real time.

8. The method for sending messages according to claim 4, wherein said display is arranged on said message composing device.

9. The method for sending messages according to claim 4, wherein said display is arranged on said communication device.

10. The method for sending messages according to claim 1, wherein said steps of setting an operating mode is performed by using a selecting unit arranged on said message composing device.

11. The method for sending messages according to claim 1, wherein said step of setting an operating mode is performed on said communication device.

12. The method for sending messages according to claim 1, further comprising the steps of detecting a change of position of said message composing device.

13. The method for sending messages according to claim 10, wherein said detected change of position corresponds to a change of said operating mode.

14. The method for sending messages according to claim 1, wherein said communicating step is provided via a wireless connection.

15. The method for sending messages according to claim 12, wherein said wireless connection is arranged in accordance with the Bluetooth wireless protocol.

16. The method for sending messages according to claim 1, wherein said communicating step is provided via a wired connection.

17. The method for sending messages according to claim 1, wherein said communication device is a mobile phone, portable computer or similar communication device.

18. A method for receiving and replying to messages by using a message composing device adapted for cooperation with a first communication device, wherein said method comprises the steps of:
receiving a message on said first communication device from a second communication device;
presenting said received message on a first display;
replying to said received message comprising the steps of
i. setting said message composing device in a writing operating mode;
ii. recognizing characters, symbols or similar information using detection of movements of said message composing device;
iii. communicating said characters, symbols or similar information to said first communication device;
iv. setting said first communication device in a sending operating mode; and
v. sending said characters, symbols or similar information dependent on said sending operating mode.

19. The method for receiving and replying to messages according to claim 18, wherein said sending operating mode is set to sending said message as an Instant message.

20. The method for receiving and replying to messages according to claim 18, wherein said sending operating mode is set to sending said message as an email.

21. The method for receiving and replying to messages according to claim 18, further comprising the step of presenting said recognized characters, symbols or similar information on said first display.

22. The method for receiving and replying to messages according to claim 18, further comprising the step of presenting said received message on a second display and presenting said recognized characters, symbols or similar information on said second display.

23. The method for receiving and replying to messages according to claim 21, wherein said presenting steps further comprises presenting said recognized characters, symbols or similar information in real time.

24. The method for receiving and replying to messages according to claim 21, wherein said first display is arranged on said communication device and said second display is arranged on said message composing device.

25. The method for receiving and replying to messages according to claim 1, wherein said communicating step is provided via a wireless connection.

26. The method for receiving and replying to messages according to claim 25, wherein said wireless connection is arranged in accordance with the Bluetooth wireless protocol.

27. The method for receiving and replying to messages according to claim 1, wherein said communicating step is provided via a wired connection.

28. The method for receiving messages according to claim 1, wherein said first and second communication devices are a mobile phone, portable computer or similar communication device.

29. A message composing device adapted for cooperation with a communication device, wherein said device comprises:
means for setting said message composing device in writing operating mode;
means for recognizing characters, symbols or similar information using means for detecting movements of said message composing device;
means for communicating said characters, symbols or similar information to said communication device; and
means for setting said communication device in a sending operating mode.

30. The device according to claim 29, wherein said sending operating mode is set to sending said characters, symbols or similar information as an Instant message.

31. The device according to claim 29, wherein said sending operating mode is set to sending said characters, symbols or similar information as an email.

32. The device according to claim 29, wherein said means for detecting movements comprises at least one accelerometer.

33. The device according to claim 29, wherein said means for detecting movements comprises at least one optical detector means.

34. The device according to claim 29, further comprising a display for presenting said characters, symbols or similar information.

35. The device according to claim 34, wherein said characters, symbols or similar information are presented in real time on said display.

36. The device according to claim 29, wherein said means for setting sending operating mode is a selecting unit provided on said device.

37. The device according to claim 29, wherein said means for detecting movements is further adapted for detecting a change of position of said device.

38. The device according to claim 37, wherein said detected change of position corresponds to a change of operating mode.

39. The device according to claim 1, wherein the said device is arranged for communicating with said communication device via a wireless connection.

40. The device according to claim 39, wherein the wireless connection is arranged in accordance with the Bluetooth wireless protocol.

41. The device according to claim 1, wherein the said device is arranged for communicating with said communication device via a wired connection.

42. The device according to claim 1, wherein said device comprises a housing which is stylus shaped.

43. The device according to claim 1, wherein said communication device is a mobile phone, portable computer or similar communication device.
